(19) United States
(12) Patent Application Publication
(10) Pub. No.: US 2007/0107285 A1
(43) Pub. Date: May 17, 2007

(54) Detachable cross-arm for real estate signs

(76) Inventor: Thomas Ischkum, Schaumburg, IL (US)

Correspondence Address: EDWIN TARVER, 16830 Ventura Blvd., SUITE 360, Encino, CA, 91436, US

(21) Appl. No.: 11/599,705

(22) Filed: Nov. 15, 2006

Related U.S. Application Data
(60) Provisional application No. 60/737,218, filed on Nov. 15, 2005.

(51) Int. Cl. G09F 15/00

(52) U.S. Cl. 40/607.09; 40/611.12

(57) ABSTRACT

A reusable real estate sign display apparatus comprising a cross-arm for supporting a real estate sign, a plate-like member attached to one end of the cross-arm, and a pair of oppositely facing L-shaped engaging members disposed on opposite sides of the plate-like member. The apparatus attaches to a post when the engaging members are aligned to receive the post, and the cross-arm is turned 90 degrees in an engaging direction.

### CROSS-REFERENCE TO RELATED APPLICATION

This is a utility patent application which claims benefit of U.S. Provisional Application Ser. No. 60/737,218 filed on Nov. 15, 2005.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to signpost assemblies, and more particularly to a detachable cross arm for real estate signposts.

Signpost assemblies mainly comprise a vertical post and a cross arm for supporting a sign. Several types of signposts have been developed in art. For example, U.S. Pat. No. 5,489,076 to Thomas discloses a support for an outdoor sign. The support has upper and lower extents that are swingably connected to move between an erect position for use and a collapsed position for storage. A cross-bar is pivotally connected to the upper extent for movement between a perpendicular relation to the support, for use, and a collapsed position for storage. However, the cross arm attachment is different from that of the present invention.

U.S. Pat. No. 6,626,406 to Olson, Jr. discloses a utility pole with removable cross arm. The pole has an aperture for receiving the cross arm. A tubular sleeve is passed through the pole aperture and fastened to the pole, and the cross arm is passed through the sleeve with its opposite ends projecting outwardly from the pole. The cross arm is connected to the sleeve to secure the cross arm in position.

U.S. Pat. No. 4,327,514 to Bourque discloses a cross arm type support having a vertical post formed from a rectangular tube having a set of internal splines. A cross arm is provided at the upper end formed from a second rectangular tube having a first channel along its lower edge and a second channel along its upper edge. The vertical posts and cross arm are mortised to form complementary notches for mounting the cross arm to the post. The post and internal splines interlock with the cross arm and channels to provide internal support and rigidity to the joint. The lower cross arm channel is formed to receive plastic hooks for attaching a hanging sign and the upper channel is formed to receive a set of plastic inserts for receiving an interchangeable rider sign.

Although the cross arms of the Olson, Jr. and Bourque references are removable, the means for attaching the cross arm of the present invention is different. The cross arm of the present invention can be easily mounted to a vertical post, without using fasteners, for hanging a sign. In one embodiment, the cross arm of the present invention can be mounted to vertical posts of existing real estate signposts.

### SUMMARY

The present invention is a cross-arm that can be detachably secured to typical real estate signposts. The cross-arm mainly comprises an elongated bar with a coupling assembly connected to the elongated bar. The elongated bar includes of plurality of rings or other suitable means for holding a real estate sign. The coupling assembly includes a rectangular area with two L-shaped members extending from the rectangular area. The rectangular area is made to abut the vertical column of a traditional real estate signpost and the L-shaped members are made to grip the vertical column of a traditional real estate signpost from two directions, anchoring the cross arm in place.

To use the present invention, the cross-arm is brought into contact with the vertical column of a traditional real estate signpost, so that the rectangular portion abuts the signpost, with the L-shaped members on either side of the signpost. The cross-arm is then rotated, so that the L-shaped members close about the vertical column, abutting it along the sides and the back of the vertical column relative to the rectangular portion. The L-shaped members along with the rectangular plate will then distribute and share the load of the cross-arm, thereby firmly securing the cross-arm on the vertical column. A second real estate sign may then be displayed on the cross-arm.

### BRIEF DESCRIPTION OF THE FIGURES

FIG. 1 is a perspective view of the cross-arm of the present invention.

FIG. 2 is a perspective view of the coupling assembly portion of the cross-arm of the present invention.

FIG. 3 is a front perspective view of the cross-arm of the present invention secured to a vertical post and holding a sign.

FIG. 4 is a rear perspective view of the cross-arm of the present invention secured to a vertical post and holding a sign.

### FIGURES—REFERENCE NUMERALS

10 . . . Cross Arm
11 . . . Vertical Post
12 . . . Elongated Bar
13 . . . Ring
14 . . . Rectangular Plate
15 . . . First L-shaped Member
16 . . . Second L-shaped Member
17 . . . First Plate-like Member
18 . . . Second Plate-like Member
19 . . . Sign

### DETAILED DESCRIPTION

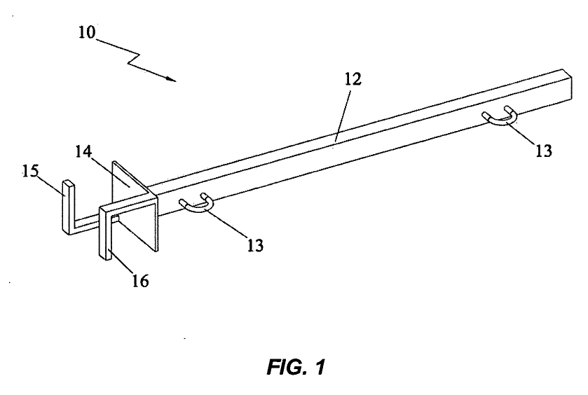

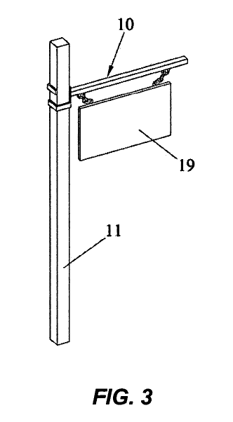

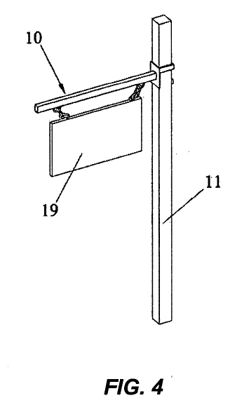

Referring to the drawings, a preferred embodiment of a cross-arm 10 is illustrated and generally indicated as 10 in FIGS. 1 through 4. The cross-arm 10 is detachably secured to a vertical post for displaying a real estate sign. The cross arm can also be secured to a vertical column of a typical real estate signpost for supporting an additional sign.

Referring to FIG. 1, the cross-arm 10 mainly comprises an elongated bar 12 and a coupling assembly. The elongated bar 12 can be of any cross-section and includes two rings 13 to hang a sign 19. The coupling assembly comprises a bracket with a rectangular plate area 14 and two L-shaped members 15 and 16. One of the ends of the elongated bar 12 is attached to the rectangular plate 14 such that the elongated bar 12 is perpendicular to the surface of the rectangular plate 14. Preferably, the bar 12 is attached in the center of the rectangular plate 14. The L-shaped members are attached to the two opposite and distal edges of the rectangular plate 14. For instance, when the first L-shaped member 15 is attached to the bottom-left edge of the rectangular plate 14, the second L-shaped member 16 is attached to the top-right edge of the rectangular plate 14 so that the L-shaped members extend away from the rectangular plate 14.

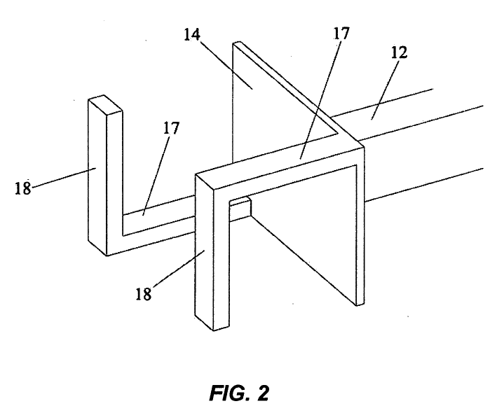

For a more detailed explanation of the securing assembly, each L-shaped member can be further categorized into two elongated plate-like members, first 17 and second 18, preferably attached at right angles to each other. Each L-shaped member is attached to the rectangular plate 14 such that the first plate-like member 17 is substantially perpendicular to the rectangular plate 14, the second plate-like member 18 is substantially parallel to the rectangular plate 14, and the second plate-like members 18 of the two L-shaped members face each other, as seen in FIG. 2.

Moreover, the two L-shaped members 15 and 16 maintain a gap of specific width between them. Preferably, this width is substantially equal to the width of the vertical post 11 to which the cross-arm 10 is secured. The vertical post 11 is preferably of square or rectangular cross section.

The cross arm 10 is first positioned such that an axis along the length of the rectangular plate 14 is perpendicular to the vertical post 11. The rectangular plate 14 is then made to abut one of the surfaces of the vertical post 11, which is made possible by the width maintained between the two L-shaped members. The cross-arm 10 is then rotated clockwise. Following which, the inner surfaces of the L-shaped members will abut the vertical column. The L-shaped members 15 and 16 along with the rectangular plate 14 will distribute and share the load appropriately, thereby firmly securing the cross-arm 10.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A real estate sign apparatus comprising:
(a) a means for supporting a sign; and
(b) a means for coupling the apparatus to a post, wherein the coupling means is aligned, brought against the post, and rotated in an engaging direction for securing the apparatus to the post.

2. The apparatus of claim 1, wherein the coupling means comprises two engaging members that are spaced apart such that they engage the post after they are aligned and rotated in the engaging direction.

3. The apparatus of claim 2, wherein the engaging members engage the post simultaneously from opposite sides of the post.

4. The apparatus of claim 3, wherein the engaging members are one above the other after the apparatus is secured to the post.

5. The apparatus of claim 2, wherein the engaging members are L-shaped.

6. The apparatus of claim 2, wherein the engaging members are curved.

7. The apparatus of claim 2, wherein the engaging members extend directly from one end of the supporting means.

8. The apparatus of claim 2, wherein the engaging members extend directly from a plate member attached to one end of the supporting means, wherein the plate member comes into a planar contact with the side the post.

9. The apparatus of claim 1, wherein the means for supporting the sign comprises a cross-arm and a means for supporting the sign from above and below.

10. The apparatus of claim 1, wherein the means for supporting the sign comprises a cross-arm and a means for hanging the sign.

11. A reusable real estate sign display apparatus, comprising:
(a) a cross arm for supporting a real estate sign;
(b) a plate-like member attached to one end of the cross-arm; and
(c) a pair of oppositely facing L-shaped engaging members disposed on opposite sides of the plate-like member, wherein the apparatus attaches to a post when the engaging members are aligned to receive the post, and the cross-arm is turned 90 degrees in an engaging direction.

12. The apparatus of claim 11, wherein the cross arm comprises a means for supporting the sign from above and below.
